(19) United States
(12) Patent Application Publication
(10) Pub. No.: US 2024/0289722 A1
(43) Pub. Date: Aug. 29, 2024

(54) Method And Device For Estimating Size Of Pre-Registration Access Prior To Launch Of Game

(71) Applicant: Kakao Games Corp., Gyeonggi-do (KR)

(72) Inventor: Daesub SONG, Gyeonggi-do (KR)

(73) Assignee: Kakao Games Corp., Gyeonggi-do (KR)

(21) Appl. No.: 18/292,832

(22) PCT Filed: Mar. 7, 2023
(86) PCT No.: PCT/KR2023/003068

§ 371 Date: Jan. 26, 2024

(30) Foreign Application Priority Data
Mar. 17, 2022 (KR) 10-2022-0033488

(51) Int. Cl. G06Q 10/0637

(52) U.S. Cl. CPC G06Q 10/06375

(57) ABSTRACT

Disclosed is a method for predicting a pre-reservation access size performed by a computing device. The method may include: obtaining a plurality of sub-information groups from first pre-reservation information for at least one first game based on a plurality of pre-reservation variable combinations; generating a prediction model group unit including a plurality of sub-prediction models based on the plurality of sub-information groups, wherein each of the plurality of the sub-prediction models is related to at least one of the plurality of sub-information groups; and determining a pre-reservation access probability of a second game by using at least one sub-prediction model corresponding to second pre-reservation information for the second game in the prediction model group unit.

### CROSS-REFERENCE TO RELATED APPLICATIONS

This application claims priority to and the benefit of Korean Patent Application No. 10-2022-0033488 filed in the Korean Intellectual Property Office on Mar. 17, 2022, the entire contents of which are incorporated herein by reference.

### TECHNICAL FIELD

The present disclosure relates to a computer technology field, and more particularly, to a method and a device for predicting a pre-reservation access size before a game launch.

### BACKGROUND ART

Pre-reservation is a type of marketing that attracts users before a new game is officially released. Game companies are using pre-reservation as a yardstick to check the success potential of a game in advance. In fact, it is easy to find cases where games that succeeded in pre-reservation are successful.

Game companies generally use the number of pre-reserved users to predict the number of accessors at a game launch and determine a server size accordingly. If the number of accessors is underestimated, problems may arise where excessive queuing occurs depending on a server load. Additionally, if the number of accessors is overestimated, the number of people per server may decrease. Since both cases are undesirable for stable game operation, it is very important to properly predict the access size.

As a methodology for predicting the access size based on the pre-reservation, there may be a method of predicting the access size using an average conversion rate and a personalized prediction method using cumulative personal information. The method of using the average conversion rate may be to predict the number of accessors by applying the average conversion rate to the number of pre-reserved users. An advantage of the method using the average conversion rate is that the average conversion rate can be calculated quickly without any special formulas and that accuracy of an average degree is guaranteed. However, the method using the average conversion rate has a disadvantage of being less likely to be used for purposes other than the pre-reservation and not having great expectations regarding accuracy. The personalized prediction method has an advantage of being highly used for purposes other than the pre-reservation and guaranteeing relatively high accuracy. However, in the case of the personalized prediction method, a prediction model may be quite complex and require a lot of time to work, and model training itself may be difficult.

Therefore, there is a demand for a method and a device for efficiently and accurately predicting the pre-reservation access size before the game launch.

### SUMMARY OF THE INVENTION

The present disclosure is contrived in response to the above background, and has been made in an effort to provide a method and a device for predicting a pre-reservation access size before a game launch.

An exemplary embodiment of the present disclosure provides a method for predicting a pre-reservation access size performed by a computing device. The method may include: obtaining a plurality of sub-information groups from first pre-reservation information for at least one first game based on a plurality of pre-reservation variable combinations; generating a prediction model group unit including a plurality of sub-prediction models based on the plurality of sub-information groups, wherein each of the plurality of the sub-prediction models is related to at least one of the plurality of sub-information groups; and determining a pre-reservation access probability of a second game by using at least one sub-prediction model corresponding to second pre-reservation information for the second game in the prediction model group unit.

Alternatively, the sub-prediction model may include a Bayesian network model.

Alternatively, the method may further include determining an anticipated pre-reservation accessor group by generating a random number based on the pre-reservation access probability of the second game.

Alternatively, the plurality of pre-reservation variable combinations may include a combination including at least one of basic user information, pre-reservation history information, and game preference information.

Alternatively, the plurality of pre-reservation variable combinations may include a combination including the basic user information.

Alternatively, the plurality of pre-reservation variable combinations may include a combination including the basic user information and the pre-reservation history information.

Alternatively, the plurality of pre-reservation variable combinations may include a combination including the basic user information and the game preference information.

Alternatively, the plurality of pre-reservation variable combinations may include a combination including the basic user information, the pre-reservation history information, and the game preference information.

Alternatively, the plurality of pre-reservation variable combinations may include the combination including the basic user information, the combination including the basic user information and the pre-reservation history information, the combination including the basic user information and the game preference information, and the combination including the basic user information, the pre-reservation history information, and the game preference information.

Another exemplary embodiment of the present disclosure provides a computing device for performing a method for predicting a pre-reservation access size. The computing device may include: a processor including at least one core; and a memory including program codes executable in the processor,, and the processor may be configured to obtain a plurality of sub-information groups from first pre-reservation information for at least one first game based on a plurality of pre-reservation variable combinations, generate a prediction model group unit including a plurality of sub-prediction models based on the plurality of sub-information groups, wherein each of the plurality of the sub-prediction models is related to at least one of the plurality of sub-information groups, and determine a pre-reservation access probability of a second game by using at least one sub-prediction model corresponding to second pre-reservation information for the second game in the prediction model group unit.

Still another exemplary embodiment of the present disclosure provides a computer program stored in a computer-readable storage medium. When the computer program is executed by one or more processors, the computer program may allow one or more processors to perform operations for performing a method for predicting a pre-reservation access size, and the method may include: obtaining a plurality of sub-information groups from first pre-reservation information for at least one first game based on a plurality of pre-reservation variable combinations; generating a prediction model group unit including a plurality of sub-prediction models based on the plurality of sub-information groups, wherein each of the plurality of the sub-prediction models is related to at least one of the plurality of sub-information groups; and determining a pre-reservation access probability of a second game by using at least one sub-prediction model corresponding to second pre-reservation information for the second game in the prediction model group unit.

The present disclosure can provide a method and a device for predicting a pre-reservation access size before a game launch.

### BRIEF DESCRIPTION OF THE DRAWINGS

FIG. 1 is a block diagram of a computing device for performing a method for predicting a pre-reservation access size according to some exemplary embodiment of the present disclosure.

FIG. 2 is a schematic view illustrating a network function according to an exemplary embodiment of the present disclosure.

FIG. 3 is a diagram for describing a processor of generating a prediction model group unit according to some exemplary embodiments of the present disclosure.

FIG. 4 is a diagram for describing a processor of determining a pre-reservation access probability by using the prediction model group unit according to some exemplary embodiments of the present disclosure.

FIG. 5 is a flowchart of a method for predicting a pre-reservation access size according to some exemplary embodiments of the present disclosure.

FIG. 6 is a simple and normal schematic view of an exemplary computing environment in which some exemplary embodiments of the present disclosure may be implemented.

### DETAILED DESCRIPTION

Various exemplary embodiments are described with reference to the drawings. In the present specification, various descriptions are presented for understanding the present disclosure.

Terms, “component”, “module”, “system”, and the like used in the present specification indicate a computer-related entity, hardware, firmware, software, a combination of software and hardware, or execution of software. For example, a component may be a procedure executed in a processor, a processor, an object, an execution thread, a program, and/or a computer, but is not limited thereto. For example, both an application executed in a computing device and a computing device may be components. One or more components may reside within a processor and/or an execution thread. One component may be localized within one computer. One component may be distributed between two or more computers. Further, the components may be executed by various computer readable media having various data structures stored therein. For example, components may communicate through local and/or remote processing according to a signal (for example, data transmitted to another system through a network, such as the Internet, through data and/or a signal from one component interacting with another component in a local system and a distributed system) having one or more data packets.

A term “or” intends to mean comprehensive “or”, not exclusive “or”. That is, unless otherwise specified or when it is unclear in context, “X uses A or B” intends to mean one of the natural comprehensive substitutions. That is, when X uses A, X uses B, or X uses both A and B, or “X uses A or B” may be applied to any one among the cases. Further, a term “and/or” used in the present specification shall be understood to designate and include all of the possible combinations of one or more items among the listed relevant items.

It should be understood that a term “include” and/or “including” means that a corresponding characteristic and/or a constituent element exists. Further, a term “include” and/or “including” means that a corresponding characteristic and/or a constituent element exists, but it shall be understood that the existence or an addition of one or more other characteristics, constituent elements, and/or a group thereof is not excluded. Further, unless otherwise specified or when it is unclear in context that a single form is indicated, the singular shall be construed to generally mean “one or more” in the present specification and the claims.

The term “at least one of A and B” should be interpreted to mean “the case including only A”, “the case including only B”, and “the case where A and B are combined”.

Those skilled in the art shall recognize that the various illustrative logical blocks, configurations, modules, circuits, means, logic, and algorithm operations described in relation to the exemplary embodiments additionally disclosed herein may be implemented by electronic hardware, computer software, or in a combination of electronic hardware and computer software. In order to clearly exemplify interchangeability of hardware and software, the various illustrative components, blocks, configurations, means, logic, modules, circuits, and operations have been generally described above in the functional aspects thereof. Whether the functionality is implemented as hardware or software depends on a specific application or design restraints given to the general system. Those skilled in the art may implement the functionality described by various methods for each of the specific applications. However, such implementation decisions should not be interpreted as causing a departure from the scope of the present disclosure.

The description about the presented exemplary embodiments is provided so as for those skilled in the art to use or carry out the present disclosure. Various modifications of the exemplary embodiments will be apparent to those skilled in the art. General principles defined herein may be applied to other exemplary embodiments without departing from the scope of the present disclosure. Therefore, the present disclosure is not limited to the exemplary embodiments presented herein. The present disclosure shall be interpreted within the broadest meaning range consistent to the principles and new characteristics presented herein.

According to some exemplary embodiments of the present disclosure, the present disclosure may provide a method and a device for predicting a pre-reservation access size. Among the methodologies for predicting the pre-reservation access size, a methodology using an average conversion rate has a problem of having a lower possibility of being used for purposes other than pre-reservation and not being able to guarantee accuracy. Additionally, in the case of a model-based methodology, there is a problem that while pre-reservation information is simple, a model for calculating a probability of access by a pre-reserved user is complex. Additionally, there are cases where it is impossible to train the model, such as when preparing to launch a game that is not similar to a previously launched game. The present disclosure can solve the above-mentioned problems by categorizing pre-reservation information and creating individual sub-models. In other words, instead of generating a single model, the present disclosure can generate a plurality of individual sub-models using various variable combinations that can be used to determine the pre-reservation access probability. Accordingly, the present disclosure can provide a method and a device for efficiently predicting the pre-reservation access size by selecting and using an appropriate sub-model for pre-reservation information collected in various forms.

The term ‘pre-reservation access probability’ may include a probability of pre-reserved user's accessing between various periods after the game launch. For example, the pre-reservation access probability may include a probability that the pre-reserved user will access the game on the day of launch (or 24 hours after launch). As another example, the term ‘pre-reservation access probability’ may include a probability that the pre-reserved user will access the game within a week after the game launch. However, the present disclosure is not limited thereto, and the pre-reservation access probability may be defined in various ways. Likewise, a period determining the term ‘pre-reservation access size’ may be defined in various ways.

FIG. 1 is a block diagram of a computing device for performing a method for predicting a pre-reservation access size according to some exemplary embodiment of the present disclosure.

As illustrated in FIG. 1, the computing device 100 may include a processor 110, a memory 130, and a network unit 150. A configuration of the computing device 100 illustrated in FIG. 1 is only an example shown through simplification. In some exemplary embodiments of the present disclosure, the computing device 100 may include other components for performing a computing configuration of the computing device 100 and only some of the disclosed components may constitute the computing device 100.

The processor 110 may be constituted by one or more cores and may include processors for data analysis and deep learning, which include a central processing unit (CPU), a general purpose graphics processing unit (GPGPU), a tensor processing unit (TPU), and the like of the computing device. The processor 110 may read a computer program stored in the memory 130 to perform data conversion, operation, generation, etc., for performing a method for predicting a pre-reservation access size according to some exemplary embodiments of the present disclosure.

According to some exemplary embodiments of the present disclosure, the processor 110 may perform steps for performing the method for predicting a pre-reservation access size described below. For example, the processor 110 may obtain a plurality of sub-information groups from first pre-reservation information for at least one first game based on a plurality of pre-reservation variable combinations. The first game may include a game for which game launch is completed through a pre-game, and the first pre-reservation information may include information collected through the pre-reservation and information collected after the game launch in relation to the first game. The processor 110 may produce a prediction model group unit including a plurality of sub-prediction models based on the plurality of sub-information groups, and here, each of the plurality of the sub-prediction models may be related to at least one of the plurality of sub-information groups. In some examples, the sub-prediction model may include a Bayesian network model. The processor 110 may predict a pre-reservation access probability of the second game by using at least one sub-prediction model corresponding to second pre-reservation information for a second game in the prediction model group unit. The second game may include a game for which game launch is being prepared, and the second pre-reservation information may include information collected through pre-reservation of the second game. However, the present disclosure is not limited thereto, and the processor 110 may perform various steps for performing the method for predicting a pre-reservation access size.

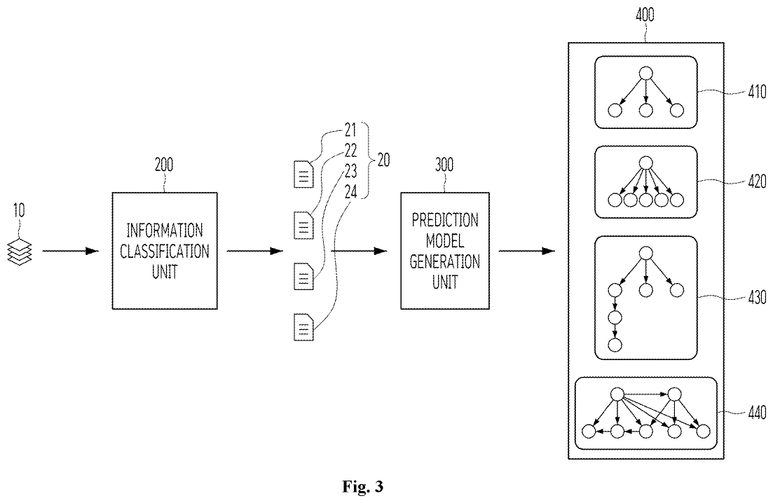

The processor 110 may implement various units and modules for performing the method for predicting a pre-reservation access size. For example, hereinafter, as described with reference to FIGS. 3 to 5, the processor 110 may implement an information classification unit 200, a prediction model generation unit 300, and a prediction model group unit 400. The information classification unit 200, the prediction model generation unit 300, and the prediction model group unit 400 may be implemented to perform various operations implemented with general computer technology in addition to the operations described herein.

The prediction model group unit (or sub-prediction model) may be a rule-based model or a machine learning model. According to some exemplary embodiments of the present disclosure, when the group prediction unit (or sub-prediction model) is the machine learning model, the processor 110 may perform an operation for training a neural network. The processor 110 may perform calculations for learning the neural network, which include processing of input data for learning in deep learning (DL), extracting a feature in the input data, calculating an error, updating a weight of the neural network using backpropagation, and the like. At least one of the CPU, the GPGPU, and the TPU of the processor 110 may process an operation related to the deep learning model. For example, the CPU and the GPGPU may process the operation related to the deep learning model jointly. Further, in some exemplary embodiments of the present disclosure, processors of a plurality of computing devices may be used together to process data conversion, operation, and generation related to the deep learning model, the learning of the network function and the data classification using the network function. Further, the computer program executed in the computing device according to some exemplary embodiments of the present disclosure may be a CPU, GPGPU, or TPU executable program.

According to some exemplary embodiments of the present disclosure, the memory 130 may store any type of information generated or determined by the processor 110 or any type of information received by the network unit 150. For example, the memory 130 may store data generated in the process of training the deep learning model by the processor 110. Additionally, the memory 130 may store data received externally, such as pre-reservation information, stored by the processor 110 in another server or device. However, the present disclosure is not limited thereto, and the memory 130 may store various information for performing the method for predicting a pre-reservation access size according to some exemplary embodiments of the present disclosure.

According to some exemplary embodiments of the present disclosure, the memory 130 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may operate in connection with a web storage performing a storing function of the memory 130 on the Internet. The description of the memory is just an example and the present disclosure is not limited thereto.

The network unit 150 according to some exemplary embodiments of the present disclosure may use an arbitrary type of known wired/wireless communication system.

The network unit 150 may transmit and receive information processed by the processor 110, a user interface, and the like through communication with other terminals. For example, the network unit 150 may provide the user interface generated by the processor 110 to a client (e.g., a user terminal). In addition, the network unit 150 may receive an external input of a user applied to a client and transfer the external input to the processor 110. In this case, the processor 110 may process operations such as outputting, correcting, changing, adding, and the like of information provided through the user interface based on the external input of the user received from the network unit 150.

Specifically, for example, the network unit 150 may transmit and receive various information for performing the method for predicting a pre-reservation access size according to some exemplary embodiments of the present disclosure. For example, the network unit 150 may receive one or more pre-reservation information or training data stored in a database. Additionally, the network unit 150 may externally transmit some data generated in the process of performing the method for predicting a pre-reservation access size described below to be stored in the database.

Meanwhile, according to some exemplary embodiments of the present disclosure, the computing device 100 may include a server as a computing system that transmits and receives information through communication with the client. In this case, the client may be any type of terminal which may access the server. For example, the computing device 100 which is the server may receive a query from a user terminal and generate a single information processing result corresponding to the query. In this case, the computing device 100 which is the server may provide, to the user terminal, a user interface including the processing result. At this time, the user terminal may output the user interface received from the computing device 100 as the server, and receive or process information through interaction with the user.

In an additional exemplary embodiment, the computing device 100 may also include any type of terminal that receives data resources generated by an arbitrary server and performs additional information processing.

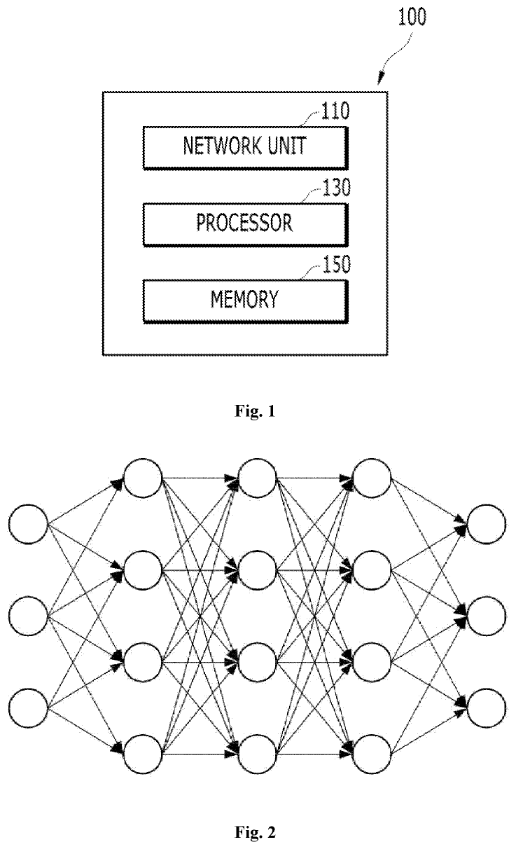

FIG. 2 is a schematic view illustrating a network function according to an exemplary embodiment of the present disclosure.

Throughout the present specification, a computation model, the neural network, a network function, and the neural network may be used as the same meaning. The neural network may be generally constituted by an aggregate of calculation units which are mutually connected to each other, which may be called nodes. The nodes may also be called neurons. The neural network is configured to include one or more nodes. The nodes (alternatively, neurons) constituting the neural networks may be connected to each other by one or more links.

In the neural network, one or more nodes connected through the link may relatively form the relationship between an input node and an output node. Concepts of the input node and the output node are relative and a predetermined node which has the output node relationship with respect to one node may have the input node relationship in the relationship with another node and vice versa. As described above, the relationship of the input node to the output node may be generated based on the link. One or more output nodes may be connected to one input node through the link and vice versa.

In the relationship of the input node and the output node connected through one link, a value of data of the output node may be determined based on data input in the input node. Here, a link connecting the input node and the output node to each other may have a weight. The weight may be variable and the weight is variable by a user or an algorithm in order for the neural network to perform a desired function. For example, when one or more input nodes are mutually connected to one output node by the respective links, the output node may determine an output node value based on values input in the input nodes connected with the output node and the weights set in the links corresponding to the respective input nodes.

As described above, in the neural network, one or more nodes are connected to each other through one or more links to form a relationship of the input node and output node in the neural network. A characteristic of the neural network may be determined according to the number of nodes, the number of links, correlations between the nodes and the links, and values of the weights granted to the respective links in the neural network. For example, when the same number of nodes and links exist and there are two neural networks in which the weight values of the links are different from each other, it may be recognized that two neural networks are different from each other.

The neural network may be constituted by a set of one or more nodes. A subset of the nodes constituting the neural network may constitute a layer. Some of the nodes constituting the neural network may constitute one layer based on the distances from the initial input node. For example, a set of nodes of which distance from the initial input node is n may constitute n layers. The distance from the initial input node may be defined by the minimum number of links which should be passed through for reaching the corresponding node from the initial input node. However, definition of the layer is predetermined for description and the order of the layer in the neural network may be defined by a method different from the aforementioned method. For example, the layers of the nodes may be defined by the distance from a final output node.

The initial input node may mean one or more nodes in which data is directly input without passing through the links in the relationships with other nodes among the nodes in the neural network. Alternatively, in the neural network, in the relationship between the nodes based on the link, the initial input node may mean nodes which do not have other input nodes connected through the links. Similarly thereto, the final output node may mean one or more nodes which do not have the output node in the relationship with other nodes among the nodes in the neural network. Further, a hidden node may mean nodes constituting the neural network other than the initial input node and the final output node.

In the neural network according to an exemplary embodiment of the present disclosure, the number of nodes of the input layer may be the same as the number of nodes of the output layer, and the neural network may be a neural network of a type in which the number of nodes decreases and then, increases again from the input layer to the hidden layer. Further, in the neural network according to another exemplary embodiment of the present disclosure, the number of nodes of the input layer may be smaller than the number of nodes of the output layer, and the neural network may be a neural network of a type in which the number of nodes decreases from the input layer to the hidden layer. Further, in the neural network according to yet another exemplary embodiment of the present disclosure, the number of nodes of the input layer may be larger than the number of nodes of the output layer, and the neural network may be a neural network of a type in which the number of nodes increases from the input layer to the hidden layer. The neural network according to still yet another exemplary embodiment of the present disclosure may be a neural network of a type in which the neural networks are combined.

A deep neural network (DNN) may refer to a neural network that includes a plurality of hidden layers in 3ddition to the input and output layers. When the deep neural network is used, the latent structures of data may be determined. That is, latent structures of photos, text, video, voice, and music (e.g., what objects are in the photo, what the content and feelings of the text are, what the content and feelings of the voice are) may be determined. The deep neural network may include a convolutional neural network (CNN), a recurrent neural network (RNN), an auto encoder, generative adversarial networks (GAN), a restricted Boltzmann machine (RBM), a deep belief network (DBN), a Q network, a U network, a Siam network, a Generative Adversarial Network (GAN), and the like. The description of the deep neural network described above is just an example and the present disclosure is not limited thereto.

In an exemplary embodiment of the present disclosure, the network function may include the auto encoder. The auto encoder may be a kind of artificial neural network for outputting output data similar to input data. The auto encoder may include at least one hidden layer and odd hidden layers may be disposed between the input and output layers. The number of nodes in each layer may be reduced from the number of nodes in the input layer to an intermediate layer called a bottleneck layer (encoding), and then expanded symmetrical to reduction to the output layer (symmetrical to the input layer) in the bottleneck layer. The auto encoder may perform non-linear dimensional reduction. The number of input and output layers may correspond to a dimension after preprocessing the input data. The auto encoder structure may have a structure in which the number of nodes in the hidden layer included in the encoder decreases as a distance from the input layer increases. When the number of nodes in the bottleneck layer (a layer having a smallest number of nodes positioned between an encoder and a decoder) is too small, a sufficient amount of information may not be delivered, and as a result, the number of nodes in the bottleneck layer may be maintained to be a specific number or more (e.g., half of the input layers or more).

The neural network may be learned in at least one scheme of supervised learning, unsupervised learning, semi supervised learning, or reinforcement learning. The learning of the neural network may be a process in which the neural network applies knowledge for performing a specific operation to the neural network.

The neural network may be learned in a direction to minimize errors of an output. The learning of the neural network is a process of repeatedly inputting learning data into the neural network and calculating the output of the neural network for the learning data and the error of a target and back-propagating the errors of the neural network from the output layer of the neural network toward the input layer in a direction to reduce the errors to update the weight of each node of the neural network. In the case of the supervised learning, the learning data labeled with a correct answer is used for each learning data (i.e., the labeled learning data) and in the case of the unsupervised learning, the correct answer may not be labeled in each learning data. That is, for example, the learning data in the case of the supervised learning related to the data classification may be data in which category is labeled in each learning data. The labeled learning data is input to the neural network, and the error may be calculated by comparing the output (category) of the neural network with the label of the learning data. As another example, in the case of the unsupervised learning related to the data classification, the learning data as the input is compared with the output of the neural network to calculate the error. The calculated error is back-propagated in a reverse direction (i.e., a direction from the output layer toward the input layer) in the neural network and connection weights of respective nodes of each layer of the neural network may be updated according to the back propagation. A variation amount of the updated connection weight of each node may be determined according to a learning rate. Calculation of the neural network for the input data and the back-propagation of the error may constitute a learning cycle (epoch). The learning rate may be applied differently according to the number of repetition times of the learning cycle of the neural network. For example, in an initial stage of the learning of the neural network, the neural network ensures a certain level of performance quickly by using a high learning rate, thereby increasing efficiency and uses a low learning rate in a latter stage of the learning, thereby increasing accuracy.

In learning of the neural network, the learning data may be generally a subset of actual data (i.e., data to be processed using the learned neural network), and as a result, there may be a learning cycle in which errors for the learning data decrease, but the errors for the actual data increase. Overfitting is a phenomenon in which the errors for the actual data increase due to excessive learning of the learning data. For example, a phenomenon in which the neural network that learns a cat by showing a yellow cat sees a cat other than the yellow cat and does not recognize the corresponding cat as the cat may be a kind of overfitting. The overfitting may act as a cause which increases the error of the machine learning algorithm. Various optimization methods may be used in order to prevent the overfitting. In order to prevent the overfitting, a method such as increasing the learning data, regularization, dropout of omitting a part of the node of the network in the process of learning, utilization of a batch normalization layer, etc., may be applied.

FIG. 3 is a diagram for describing a processor of generating a prediction model group unit 400 according to some exemplary embodiments of the present disclosure.

Referring to FIG. 3, an exemplary process in which the processor 110 generates the prediction model group unit 400 using pre-reservation information for a game for which launch is completed through pre-reservation is described.

According to some exemplary embodiments of the present disclosure, the processor 110 may obtain a plurality of sub-information groups 20 from first pre-reservation information 10 for at least one first game based on a plurality of pre-reservation variable combinations.

The first pre-reservation information 10 may include information on a user (or pre-reserved user) or game related to the game that has been launched is completed through the pre-reservation. Here, the game that has been launched is completed through the pre-reservation may be referred to as the first game for convenience. In some examples, the first pre-reservation information may include information on the pre-reserved user and information on the pre-reserved game. The information on the pre-reserved user may include a gender, an age, an access history, a payment history, preferred game information, game play information, etc., of the user. The information on the pre-reserved game may include information (connection status, connection date, play time, paid payment status, etc.) on participation in the pre-reservation, a genre of the pre-reserved game, etc. However, the present disclosure is not limited thereto and the first pre-reservation information 10 may include various information.

Since the pre-reservation may be made through various paths, the first pre-reservation information 10 may be obtained by collecting various information through various paths. For example, when the pre-reservation is made through a platform, user information (gender, age, residence, contact information, etc.) entered by the user to use the platform may be collected as the first pre-reservation information. Additionally, when the platform provides a game service, information on games played by the user may be collected as the first pre-reservation information. As another example, when the pre-reservation is made without logging in through an advertising banner, information entered through the advertising banner may be collected as the first pre-reservation information. However, the present disclosure is not limited thereto and the first pre-reservation information may be collected in various forms.

According to some exemplary embodiments of the present disclosure, the plurality of pre-reservation variable combinations may include a combination including at least one of basic user information, pre-reservation history information, and game preference information.

The plurality of pre-reservation variable combinations may be used to refine the variables included in the pre-reservation information by category. For example, the variables included in the pre-reservation information may be classified into the basic user information, the pre-reservation history information, and the game preference information. In some examples, the basic user information may include information on the user (or pre-reserved user). For example, the basic user information may include gender, age, access history, payment history, etc. In some examples, the pre-reservation history information may include information on past pre-reservation. For example, the pre-reservation history information may include information (e.g., the genre of the pre-reserved game, etc.) on a game pre-reserved in the past, and information on the degree of participation in past pre-reservation. In some examples, the game preference information may include information for determining the similarity between the first game and the game (referred to as the second game for convenience) for which the game is to be launched through the pre-reservation. For example, the game preference information may include information on a preferred game entered by the user, and information (e.g., list of games purchased or downloaded, game genre, game play time, game progress, completion ratio, etc.) on a game played by the user. However, the present disclosure is not limited to this, and the basic user information, the pre-reservation history information, and the game preference information may include various types of information.

The plurality of pre-reservation variable combinations may include various combinations of the basic user information, the pre-reservation history information, and the game preference information. For example, the plurality of pre-reservation variable combinations may include four combinations. Here, the four combinations may include a first combination including the basic user information, a second combination including the basic user information and the pre-reservation history information, a third combination including the basic user information and the game preference information, and a fourth combination including the basic user information, the pre-reservation history information and the game preference information. However, the present disclosure is not limited thereto and the plurality of pre-reservation variable combinations may include combinations of various information.

Referring to FIG. 3, in order to obtain the plurality of sub-information groups 20, the processor 110 may generate the plurality of sub-information groups 20 from the first pre-reservation information according to the plurality of pre-reservation variable combinations by the information classification unit 200. For example, the information classification unit 200 extracts information corresponding to the first combination including the basic user information in the first pre-reservation information 10 to generate one sub-information group. As another example, the information classification unit 200 extracts information corresponding to the first combination including the basic user information, and the second combination including the basic user information and the pre-reservation history information, respectively to generate two sub-information groups. As still another example, the information classification unit 200 extracts information corresponding to the first combination including the basic user information, the second combination including the basic user information and the pre-reservation history information, the third combination including the basic user information and the game preference information, and the fourth combination including the basic user information, the pre-reservation history information and the game preference information, respectively to generate four sub-information groups. However, the information classification unit 200 is not limited to this, and may generate the plurality of sub-information groups 20 from the first pre-reservation information in various ways.

According to some exemplary embodiments of the present disclosure, the processor 110 may generate the prediction model group unit 400 including the plurality of sub-prediction models 410, 420, 430, and 440 based on the plurality of sub-information groups 20. Here, each of the plurality of sub-prediction models may be related to at least one of the plurality of sub-information groups 20.

When a plurality of sub-information groups 20 are obtained from the first pre-reservation information, the processor 110 uses the plurality of sub-information groups 20 to generate the prediction model group unit 400 by the prediction model generation unit 300. The prediction model group unit 400 may include a plurality of sub-prediction models 410, 420, 430, and 440. Referring to FIG. 3, the prediction model group unit 400 may include fourth sub-prediction models 410, 420, 430, and 440. However, this is just an example, and the prediction model group unit 400 may include various numbers of sub-prediction models.

Each of the plurality of sub-prediction models 410, 420, 430, and 440 may be related to at least one of the plurality of sub-information groups 20. For example, one sub-prediction model may be generated by using one sub-information group. Specifically, for example, the sub-prediction model 410 may be generated by training a network through the sub-information group 21. In this case, three different sub-prediction models 420, 430, and 440 may be generated by training the network through different sub-information groups 22, 23, and 24, respectively.

In this case, each sub-prediction model may be optimized for the combination of information included in the sub-information group used to generate the sub-prediction model. For example, a sub-prediction model trained using the sub-information group of the first combination including the basic user information may show optimal prediction performance for the pre-reservation information collected in the form of the first combination. As another example, a sub-prediction model trained using the sub-information group of the second combination including the basic user information and the pre-reservation history information may show optimal prediction performance for the pre-reservation information collected in the form of the second combination. Here, the present disclosure is not limited thereto, and each of the plurality of sub-prediction models may be generated in various ways in relation to at least one of the plurality of sub-information groups 20.

According to some exemplary embodiments of the present disclosure, the sub-prediction model may be the Bayesian network model.

The sub-prediction models may be implemented through various algorithms. For example, the sub-prediction model may be the Bayesian network model. In some examples, the Bayesian network model may be a probabilistic graphical model (PGM) that represents causal relationships between probabilistic variables in the form of a graph and then learns the distribution of the probabilistic variables for given data. In respect to the latest deep learning models, a larger model is trained with more data, but as the model becomes larger, it becomes more difficult to interpret, and therefore, it may be unclear how reliable the output values of deep learning models that are difficult to interpret can be. Additionally, if the training data has a high noise rate or if data not used for training is input to the model, such a model may not be able to generate an accurate prediction value. The Bayesian network model may have robust characteristics against the above-mentioned problems in that the Bayesian network model has a feature of quantifying uncertainty about models or phenomena. In other words, the present disclosure may refine pre-reservation information according to a plurality of pre-reservation variable combinations and generate a prediction model based on the Bayesian network model using the refined information (sub-information group). Specifically, the present disclosure generates the prediction model group unit 400 including the plurality of sub-prediction models based on the Bayesian network model using the plurality of sub-information groups obtained according to the plurality of pre-reservation variable combinations to provide a prediction model suitable for various pre-reservation information.

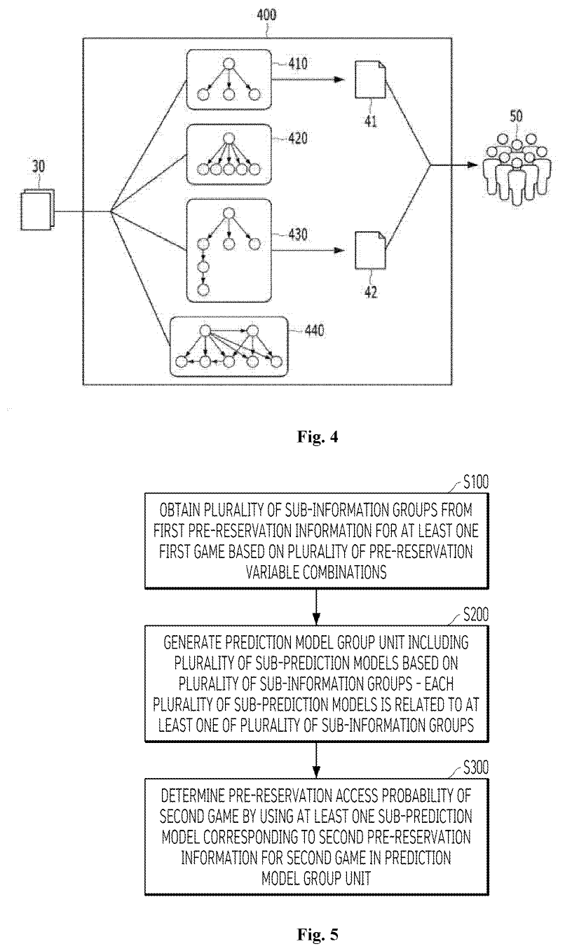

FIG. 4 is a diagram for describing a processor of determining a pre-reservation access probability by using the prediction model group unit 400 according to some exemplary embodiments of the present disclosure.

According to some exemplary embodiments of the present disclosure, the processor 110 may determine a pre-reservation access probability of the second game by using at least one sub-prediction model 410, 420, 430, and 440 corresponding to the second pre-reservation information for the second game in the prediction model group unit 400.

The second game may include a game for which game launch is being prepared. In addition, the second pre-reservation information 30 may include information collected through the pre-reservation of the second game. In some examples, the processor 110 may use the prediction model group unit 400 to obtain the second pre-reservation information 30 to predict the pre-reservation access size before the game launch.

Since the pre-reservation may be made through various paths, the second pre-reservation information 30 may be obtained by collecting various information through various paths like the first pre-reservation information 10. For example, when the pre-reservation is made through the platform, user information entered by the user to use the platform may be collected as the second pre-reservation information 30. Additionally, when the platform provides the game service, information on games played by the user may be collected as the second pre-reservation information 30. As another example, when the pre-reservation is made without logging in through the advertising banner, information entered through the advertising banner may be collected as the second pre-reservation information. In some examples, the second pre-reservation information may include one type of information. As another example, the second pre-reservation information may simultaneously include various types of information. However, the present disclosure is not limited thereto and the second pre-reservation information may be collected in various forms.

When the prediction model group unit 400 including the plurality of sub-prediction models is generated, the processor 110 may perform an operation to predict the pre-reservation access size by using the prediction model group unit 400. Referring to FIG. 4, the processor 110 may obtain the pre-reservation access probabilities 41 and 42 by using the sub-prediction models 410 and 430 corresponding to the second pre-reservation information 30 in the prediction model group unit 400. In this case, the processor 110 determines the number of pre-reservation access persons by using the pre-reservation access probabilities 41 and 42 obtained by the prediction model group unit 400 to determine the pre-reservation access size.

Specifically, the prediction model group unit 400 may determine the sub-prediction model corresponding to the second pre-reservation information 30 when receiving the second pre-reservation information 30. For example, when the second pre-reservation information 30 is the information of the first combination type including the basic user information, the prediction model group unit 400 may determine that the sub-prediction model related to the sub-information group of the first combination corresponds to the second pre-reservation information 30. As another example, when the second pre-reservation information 30 is the information of the first combination type including the basic user information and the information of the third combination type including the basic user information and the game preference information, the prediction model group unit 400 may determine that sub-prediction models related to the sub-information groups of the first combination and the third combination correspond to the second pre-reservation information 30.

When one or more sub-prediction models corresponding are determined, the prediction model group unit 400 may determine one or more pre-reservation access probabilities by using one or more corresponding sub-prediction models. In this case, the prediction model group unit 400 may predict the pre-reservation access size by applying the pre-reservation access probability to a pre-reserved user group. In some examples, if the pre-reservation access probability is 40% and the number of user groups for the second pre-reservation information is 3 million, the prediction model group unit 400 may predict 2.2 million people as the number of pre-reservation access persons. As another example, when the second pre-reservation information includes the information of the first combination and the information of the fourth combination, the second pre-reservation information is processed by the prediction model group unit 400, so the sub-prediction model related to the sub-information group of the first combination may determine a pre-reservation access probability of 20% and a sub-prediction model related to the sub-information group of the fourth combination may determine a pre-reservation access probability of 30%. In this case, for example, when the number of user groups related to the information of the first combination in the second pre-reservation information is 1 million and the number of user groups related to the information of the fourth combination in the second pre-reservation information is 0.5 million, the prediction model group unit 400 may predict 0.35 million as the number of pre-reservation access persons. However, the present disclosure is not limited thereto, and the prediction model group unit 400 may determine the pre-reservation access probability from the second pre-reservation information in various ways using one or more corresponding sub-prediction models.

As described above, the prediction model group unit 400 according to the present disclosure selects/uses an appropriate sub-prediction model according to a blank of the collected pre-reservation information to effectively predict the pre-reservation access size. Therefore, it may be efficient that the prediction model group unit 400 according to the present disclosure predicts the pre-reservation access size from the pre-reservation information collected in various forms.

In some exemplary embodiments of the present disclosure, the processor 110 generates a random number based on the pre-reservation access probability of the second game to determine an anticipated pre-reservation accessor group.

When the pre-reservation access probability is determined, the processor 110 may specify a pre-reservation accessor group anticipated to access upon game launch. For example, the processor 110 may generate the random number based on the pre-reservation access probability of the second game. The generated random number may be used for specifying the pre-reservation accessor group anticipated to access among the user groups related to the second pre-reservation information. Specifically, individual users reserved to access according to the pre-reservation may be probabilistically specified according to the random number distribution among all user groups. information on a specific pre-reservation accessor may be used for additional marketing such as conducting an additional promotion by applying the random number. However, the present disclosure is not limited thereto, and the processor 110 may specify a pre-reservation accessor group anticipated to access upon game launch in various ways.

FIG. 5 is a flowchart of a method for predicting a pre-reservation access size according to some exemplary embodiments of the present disclosure.

According to some exemplary embodiments of the present disclosure, the method may include a step s100 of obtaining the plurality of sub-information groups from the first pre-reservation information for at least one first game based on the plurality of pre-reservation variable combinations.

According to some exemplary embodiments of the present disclosure, the method may include a step s200 of generating the prediction model group unit including the plurality of sub-prediction models based on the plurality of sub-information groups. Here, each of the plurality of sub-prediction models may be related to at least one of the plurality of sub-information groups.

According to some exemplary embodiments of the present disclosure, the method may include a step s300 of determining the pre-reservation access probability of the second game by using at least one sub-prediction model corresponding to the second pre-reservation information for the second game in the prediction model group unit.

Alternatively, according to some exemplary embodiments of the present disclosure, the method may further include a step of determining the anticipated pre-reservation accessor group by generating the random number based on the pre-reservation access probability of the second game.

The steps according to the method described above are presented just for description, and some steps may be omitted or separate steps may be added. Further, the steps of the present disclosure described above may be performed according to an arbitrary order.

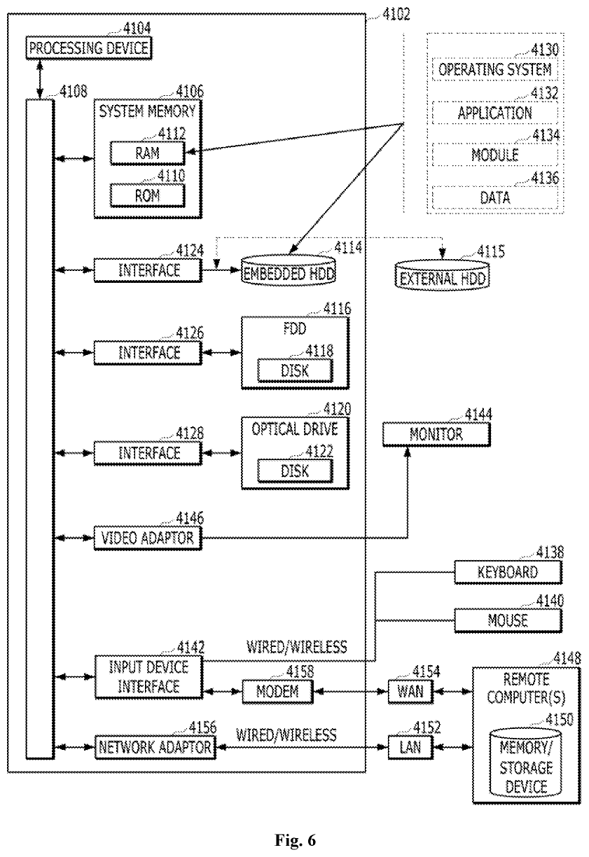

FIG. 6 is a simple and general schematic view of an exemplary computing environment in which exemplary embodiments of the present disclosure may be implemented.

It is described above that the present disclosure may be generally implemented by the computing device, but those skilled in the art will well know that the present disclosure may be implemented in association with a computer executable command which may be executed on one or more computers and/or in combination with other program modules and/or as a combination of hardware and software.

In general, the program module includes a routine, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a main frame computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media. The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable command, the data structure, the program module, or other data in a carrier wave or a modulated data signal such as other transport mechanism and include all information transfer media. The term “modulated data signal” means a signal acquired by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an interior hard disk drive (HDD) 1114 (for example, EIDE and SATA), in which the interior hard disk drive 1114 may also be configured for an exterior purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD, and the like). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. An interface 1124 for implementing an exterior drive includes at least one of a universal serial bus (USB) and an IEEE 1394 interface technology or both of them.

The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable media, the mobile optical media such as the HDD, the mobile magnetic disk, and the CD or the DVD are mentioned, but it will be well appreciated by those skilled in the art that other types of media readable by the computer such as a zip drive, a magnetic cassette, a flash memory card, a cartridge, and others may also be used in an exemplary operating environment and further, the predetermined media may include computer executable commands for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may also be cached in the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes other peripheral output devices (not illustrated) such as a speaker, a printer, others.

The computer 1102 may operate in a networked environment by using a logical connection to one or more remote computers including remote computer(s) 1148 through wired and/or wireless communication. The remote computer(s) 1148 may be a workstation, a computing device computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158 or has other means that configure communication through the WAN 1154 such as connection to a communication computing device on the WAN 1154 or connection through the Internet. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least three devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11(a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5 GHz wireless bands or operate in a product including both bands (dual bands).

It will be appreciated by those skilled in the art that information and signals may be expressed by using various different predetermined technologies and techniques. For example, data, instructions, commands, information, signals, bits, symbols, and chips which may be referred in the above description may be expressed by voltages, currents, electromagnetic waves, magnetic fields or particles, optical fields or particles, or predetermined combinations thereof.

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as software), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Various embodiments presented herein may be implemented as manufactured articles using a method, a device, or a standard programming and/or engineering technique. The term manufactured article includes a computer program, a carrier, or a medium which is accessible by a predetermined computer-readable storage device. For example, a computer-readable storage medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but the method claims are not limited to the presented specific order or hierarchical structure.

The description of the presented exemplary embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the exemplary embodiments presented herein, but should be interpreted within the widest range which is coherent with the principles and new features presented herein.

What is claimed is:

1. A method for predicting a pre-reservation access size performed by a computing device, the method comprising:
obtaining a plurality of sub-information groups from first pre-reservation information for at least one first game based on a plurality of pre-reservation variable combinations;
generating a prediction model group unit including a plurality of sub-prediction models based on the plurality of sub-information groups, wherein each of the plurality of the sub-prediction models is related to at least one of the plurality of sub-information groups; and
determining a pre-reservation access probability of a second game by using at least one sub-prediction model corresponding to second pre-reservation information for the second game in the prediction model group unit.

2. The method of claim 1, wherein the sub-prediction model includes a Bayesian network model.

3. The method of claim 1, further comprising:
determining an anticipated pre-reservation accessor group by generating a random number based on the pre-reservation access probability of the second game.

4. The method of claim 1, wherein the plurality of pre-reservation variable combinations include a combination including at least one of basic user information, pre-reservation history information, and game preference information.

5. The method of claim 4, wherein the plurality of pre-reservation variable combinations include a combination including the basic user information.

6. The method of claim 4, wherein the plurality of pre-reservation variable combinations include a combination including the basic user information and the pre-reservation history information.

7. The method of claim 4, wherein the plurality of pre-reservation variable combinations include a combination including the basic user information and the game preference information.

8. The method of claim 4, wherein the plurality of pre-reservation variable combinations include a combination including the basic user information, the pre-reservation history information, and the game preference information.

9. The method of claim 4, wherein the plurality of pre-reservation variable combinations include
the combination including the basic user information,
the combination including the basic user information and the pre-reservation history information,
the combination including the basic user information and the game preference information, and
the combination including the basic user information, the pre-reservation history information, and the game preference information.

10. A computing device for performing a method of predicting a pre-reservation access size, comprising:
a processor including at least one core; and
a memory including program codes executable in the processor,
wherein the processor is configured to:
obtain a plurality of sub-information groups from first pre-reservation information for at least one first game based on a plurality of pre-reservation variable combinations,
generate a prediction model group unit including a plurality of sub-prediction models based on the plurality of sub-information groups, wherein each of the plurality of the sub-prediction models is related to at least one of the plurality of sub-information groups, and
determine a pre-reservation access probability of a second game by using at least one sub-prediction model corresponding to second pre-reservation information for the second game in the prediction model group unit.

11. A computer program stored in a computer-readable storage medium, wherein when the computer program is executed by one or more processors, the computer program allows one or more processors to perform operations for performing a method of predicting a pre-reservation access size, and the method comprises:
obtaining a plurality of sub-information groups from first pre-reservation information for at least one first game based on a plurality of pre-reservation variable combinations;
generating a prediction model group unit including a plurality of sub-prediction models based on the plurality of sub-information groups, wherein each of the plurality of the sub-prediction models is related to at least one of the plurality of sub-information groups; and
determining a pre-reservation access probability of a second game by using at least one sub-prediction model corresponding to second pre-reservation information for the second game in the prediction model group unit.
